(19) United States
(12) Patent Application Publication
(10) Pub. No.: US 2019/0128737 A1
(43) Pub. Date: May 2, 2019

(54) SPECTROMETRIC APPARATUS AND SPECTROMETRIC METHOD

(71) Applicant: Seiko Epson Corporation, Tokyo (JP)

(72) Inventor: Daisuke SAITO, Matsumoto (JP)

(21) Appl. No.: 16/171,487

(22) Filed: Oct. 26, 2018

(30) Foreign Application Priority Data
Oct. 27, 2017 (JP) 2017-207920

(51) Int. Cl. G01J 3/10; G01J 3/44; G01J 3/02

(52) U.S. Cl. CPC G01J 3/10; G01J 3/0232; G01J 3/0262; G01J 3/4406

(57) ABSTRACT

A spectrometric apparatus includes: an excitation light source that outputs excitation light to a measurement target; a light source control section that controls driving of the excitation light source; and a measurement section that performs spectrometry of light reflected by the measurement target, in which a plurality of types of the excitation light sources are provided corresponding to a plurality of types of fluorescence having different peak wavelengths, and in which the light source control section sequentially changes the excitation light sources to be turned on in a manner to turn on one type of the excitation light sources among the plurality of types of the excitation light sources and turn off other types of excitation light sources.

### BACKGROUND

### 1. Technical Field

The present invention relates to a spectrometric apparatus and a spectrometric method.

### 2. Related Art

In the related art, in a printing apparatus, there is known an apparatus for detecting a fluorescent component contained in a medium (measurement target), such as a paper surface (for example, refer to JP-A-2009-236486).

The apparatus described in JP-A-2009-236486 is an apparatus for measuring optical characteristics of a fluorescent whitening agent contained in the paper surface. In the apparatus, in order to measure the fluorescent whitening agent, a violet LED and an ultraviolet LED are included, and fluorescence at 450 nm excited by light output from the violet LED or the ultraviolet LED is measured.

However, as an image to be printed by the printing apparatus, there is a case where an image formed by ink having a fluorescent color, such as fluorescent pink or fluorescent yellow, is included. Since the fluorescent color excites even in light in a wavelength range longer than the violet LED or the ultraviolet LED and emits fluorescence, colorimetry with high accuracy under the optional illumination cannot be performed. In other words, in the color measurement in an image including the fluorescent color, fluorescence measurement using the light in the wavelength range longer than the violet LED or the ultraviolet LED as a light source is also necessary.

In the above-described JP-A-2009-236486, the fluorescence of the fluorescent whitening agent excited by excitation light from the violet LED or the ultraviolet LED is measured. However, with respect to the fluorescent color excites even in light in the wavelength range longer than the violet LED or the ultraviolet LED, and emits the fluorescent light, it is difficult to perform the colorimetry with high accuracy under the optional illumination.

### SUMMARY

An advantage of some aspects is to provide a spectrometric apparatus and a spectrometric method capable of measuring respective fluorescence properties of a plurality of types of fluorescence with high accuracy.

A spectrometric apparatus according to an application example of the invention includes: an excitation light source that outputs excitation light to a measurement target; a light source control section that controls driving of the excitation light source; and a measurement section that performs spectrometry of light reflected by the measurement target, in which a plurality of types of the excitation light sources are provided corresponding to a plurality of types of fluorescence having different peak wavelengths, and in which the light source control section sequentially changes the excitation light sources to be turned on in a manner to turn on one type of the excitation light sources among the plurality of types of the excitation light sources and turn off other types of excitation light sources.

In the application example, the plurality of types of excitation light sources that correspond to the plurality of types of fluorescence having different wavelengths are provided, and the excitation light sources are turned on alternately. In other words, the wavelengths of the excitation light with which the measurement target is irradiated are alternately switched. Accordingly, even in a case where the plurality of types of fluorescent materials are included in the measurement target, the excitation light is alternately switched, and thus, the excited fluorescent materials alternately change, and the plurality of types of fluorescence are alternately emitted. Accordingly, by measuring the fluorescence by the measurement sections respectively, it is possible to respectively individually measure the fluorescence properties with respect to the plurality of types of fluorescence with high accuracy.

In the spectrometric apparatus according to the application example, it is preferable that the excitation light source includes a first excitation light source that outputs first excitation light having a peak wavelength in a wavelength range of 420 nm or more and less than 490 nm.

As a fluorescent material (yellow fluorescent material) for generating a yellow fluorescent color (hereinafter, referred to as fluorescent yellow), for example, there is a material which is excited by excitation light in a range of from ultraviolet light to approximately 510 nm and emits fluorescence having a peak wavelength (fluorescence wavelength) of 519 nm.

However, for example, in an image or the like in which the paper surface is coated with yellow fluorescent ink (yellow fluorescent material) or the like, when a fluorescent component is measured using the excitation light in the wavelength range of ultraviolet to less than 420 nm, and colorimetry is performed under the optional illumination, the accuracy is low. This is because the fluorescent yellow is also excited by excitation light of approximately 420 nm to 510 nm to generate fluorescence as described above, but the fluorescent component thereof is not included in colorimetry.

Meanwhile, in the application example, in addition to the excitation light source in the wavelength range of ultraviolet to less than 420 nm, the first excitation light source outputs the first excitation light having the peak wavelength in the wavelength range of 420 nm or more and less than 490 nm.

Accordingly, the fluorescence properties of fluorescent yellow can be measured with high accuracy, and the colorimetry with high accuracy under the optional illumination can be performed.

In the spectrometric apparatus according to the application example, it is preferable that the excitation light source includes a second excitation light source that outputs second excitation light having a peak wavelength in a wavelength range of 490 nm or more and less than 600 nm.

As a fluorescent material (pink fluorescent material) for generating a pink fluorescent color (hereinafter, referred to as fluorescent pink), for example, there is a material which is excited by excitation light in a range of from ultraviolet light to approximately 600 nm and emits fluorescence having a peak wavelength (fluorescence wavelength) of 606 nm.

However, in a case where an image is formed of fluorescent ink containing the yellow fluorescent material and the pink fluorescent material on the paper surface, when the fluorescent component is measured using the excitation light in the wavelength range less than 490 nm, and colorimetry is performed under the optional illumination, the accuracy is low. This is because the fluorescent pink is also excited by excitation light of approximately 490 nm to 600 nm to generate fluorescence as described above, but the fluorescent component thereof is not included in colorimetry.

Meanwhile, in the application example, in addition to the excitation light source in the wavelength range less than 490 nm, the second excitation light source is provided and outputs the second excitation light having the peak wavelength in the wavelength range of 490 nm or more and less than 600 nm. Accordingly, the fluorescence properties of fluorescent pink can be measured with high accuracy, and the colorimetry with high accuracy under the optional illumination can be performed.

In the spectrometric apparatus according to the application example, it is preferable that the excitation light source includes a third excitation light source that outputs third excitation light having a peak wavelength in a wavelength range of 380 nm or more and less than 420 nm.

With such a third excitation light source, it is possible to measure the fluorescence properties in the excitation light of 380 nm or more and less than 420 nm of the fluorescent whitening agent, the fluorescent yellow, and the fluorescent pink. Accordingly, by combining the fluorescence properties obtained by the first excitation light source and the second excitation light source to each other, it is possible to obtain the fluorescence properties of the fluorescent whitening agent, the fluorescent yellow, and the fluorescent pink which are required for the colorimetry under the optional illumination.

In the spectrometric apparatus according to the application example, it is preferable that a white light source for outputting white light to the measurement target is further provided, and the light source control section controls driving of the excitation light source and the white light source, turns off the white light source while the excitation light source is turned on, and turns off the excitation light source while the white light source is turned on.

In the application example, by performing the measurement using the white light source, colorimetric processing (for example, calculation of reflectance for each wavelength or calculation of color coordinate values, such as RGB) can be performed with respect to the measurement target. In addition, by combining the measurement result using the white light source and the fluorescence properties obtained by the first excitation light source, the second excitation light source, and the third excitation light source, colorimetry with high accuracy under the optional illumination becomes possible.

In the spectrometric apparatus according to the application example, it is preferable that a light shielding section that is provided so as to be capable of advancing and retreating on an optical path of the white light output from the white light source, and a light shielding control section that controls movement of the light shielding section, are further provided, and the light shielding control section moves the light shielding section on the optical path of the white light when turning on the excitation light source.

In the above-described application example, when turning on the excitation light source, the white light source is turned off, and thus, the measurement target is not directly irradiated with the white light when the fluorescence measurement is performed. However, there is a case where the white light source receives the excitation light of the excitation light source and emits light, and in this case, the measurement target is also irradiated with the light from the white light source.

Meanwhile, in the application example, the light shielding section is provided on the optical path from the white light source to the measurement target, and when the excitation light source is turned on, the light from the white light source is shielded by the light shielding section. Accordingly, inconvenience that light other than the excitation light is incident on the measurement target can be suppressed, and the fluorescence properties can be measured with high accuracy.

In the spectrometric apparatus according to the application example, it is preferable that the plurality of types of excitation light sources are respectively provided and are disposed along a circumferential direction of a virtual circle around the measurement section when viewed from a direction oriented toward the measurement section from the measurement target.

In the application example, the excitation light source is disposed along the circumferential direction of the virtual circle around the measurement section. Accordingly, the distance or the angle from each of the excitation light sources to the measurement target can be made uniform, and the fluorescence measurement for each of the fluorescent colors can be performed with high accuracy. In addition, in a case where there are irregularities in the measurement target, in a case where there is only one light source, there is a case where shadows can be formed, and accordingly, the measurement with high accuracy cannot be performed. Meanwhile, in the application example, the plurality of types of excitation light sources are respectively provided, and the measurement target is irradiated with the light from the directions different each other, and thus, the influence of the shadow can be suppressed and the measurement with high accuracy can be performed.

A spectrometric method according to another application example of the invention uses a spectrometric apparatus including a plurality of types of excitation light sources that output excitation light to a measurement target, and have different wavelengths of the excitation light, and a measurement section that performs spectrometry of light reflected by the measurement target, the method including: measuring the light reflected by the measurement target by the measurement section while sequentially changing the excitation light source to be turned on in a manner to turn on one type of the excitation light sources among the plurality of types of the excitation light sources and turn off other types of excitation light sources.

In the application example, similar to the above-described application example, the fluorescence properties for each of the plurality of types of fluorescence can be measured with high accuracy.

### BRIEF DESCRIPTION OF THE DRAWINGS

The invention will be described with reference to the accompanying drawings, wherein like numbers reference like elements.

FIG. 1 is an external view illustrating a schematic configuration of a printer according to one embodiment of the invention.

FIG. 2 is a block diagram illustrating a schematic configuration of the printer according to the embodiment.

FIG. 3 is a sectional view illustrating a schematic configuration of a spectroscope (spectrometric apparatus) according to the embodiment.

FIG. 4 is a plan view when a light source section according to the embodiment is viewed from a +Z side.

FIG. 5 is a view illustrating a relationship between a wavelength of excitation light and a wavelength of fluorescence of fluorescent yellow excited by the excitation light.

FIG. 6 is a view illustrating a relationship between the wavelength of the excitation light and a wavelength of fluorescence of fluorescent pink excited by the excitation light.

FIG. 7 is a view illustrating a relationship between the wavelength of the excitation light and a wavelength of fluorescence of a fluorescent whitening agent excited by the excitation light.

FIG. 8 is a plan view in a case where a shutter is at a light shielding position when the light source section and the shutter of the embodiment are viewed from the +Z side.

FIG. 9 is a plan view in a case where the shutter is at an open position when the light source section and the shutter of the embodiment are viewed from the +Z side.

FIG. 10 is a flowchart illustrating spectrometry processing in the embodiment.

### DESCRIPTION OF EXEMPLARY EMBODIMENTS

Hereinafter, an embodiment of the invention will be described.

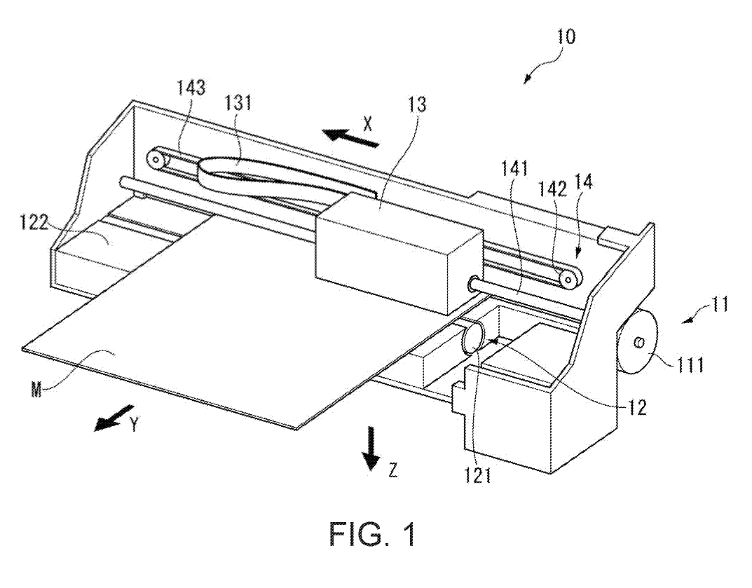

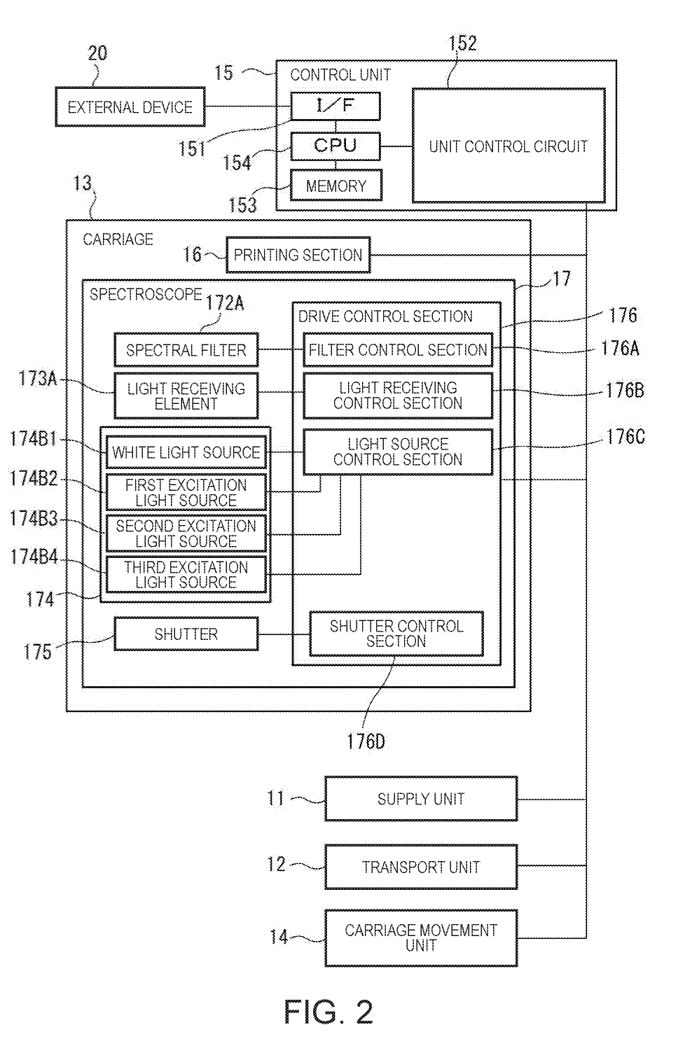

In the embodiment, a printer provided with a spectroscope which is a spectrometric apparatus will be described as an example. FIG. 1 is an external view illustrating a schematic configuration of a printer 10 according to the embodiment. In addition, FIG. 2 is a block diagram illustrating a schematic configuration of the printer 10 according to the embodiment.

As illustrated in FIG. 1, the printer 10 includes a supply unit 11, a transport unit 12, a carriage 13, a carriage movement unit 14, and a control unit 15 (refer to FIG. 2). The printer 10 controls each of the units 11, 12, and 14 and the carriage 13 based on printing data input from an external device 20, such as a personal computer, and prints an image on a medium M (measurement target). In addition, the printer 10 of the embodiment forms a test pattern for colorimetry at a predetermined position on the medium M based on preset calibration printing data, and performs spectrometry on the test pattern. Accordingly, the printer 10 performs colorimetric processing based on the spectrometry result on the test pattern, and performs correction processing, such as print correction, corresponding to the result.

Hereinafter, each configuration of the printer 10 will be specifically described.

The supply unit 11 is a unit that supplies the medium M which is an image formation target to an image forming position. The supply unit 11 includes, for example, a roll body 111 (refer to FIG. 1) around which the medium M is wound, a roll drive motor (not illustrated), a roll drive wheel train (not illustrated), and the like. In addition, based on an instruction from the control unit 15, the roll drive motor is rotationally driven, and thus, the roll body 111 rotates via the roll drive wheel train, and a paper surface wound around the roll body 111 is supplied to the downstream side (+Y side) in an auxiliary scanning direction (Y direction).

In addition, in the embodiment, an example of supplying the paper surface wound around the roll body 111 is illustrated, but the invention is not limited thereto. For example, the medium M may be supplied by any supplying method, such as supplying the media M, such as paper surfaces stacked on a tray, by a roller or the like one by one.

The transport unit 12 transports the medium M supplied from the supply unit 11 along the Y direction. The transport unit 12 includes, for example, a transport roller 121, a driven roller (not illustrated) which is disposed to sandwich the medium M with the transport roller 121 therebetween and is driven by the transport roller 121, and a platen 122.

The transport roller 121 is rotated by driving a transport motor (not illustrated) under the control of the control unit 15, and transports the medium M along the Y direction in a state where the medium M is sandwiched between the transport roller 121 and the driven roller. Further, on the +Y side of the transport roller 121, the platen 122 opposing the carriage 13 is provided.

The carriage 13 includes a printing section 16 that prints an image on the medium M and a spectroscope 17 (spectrometric apparatus) that performs spectrometry at a predetermined measurement position on the medium M.

The carriage 13 is provided so as to be movable along a main scanning direction (X direction) intersecting with the Y direction by the carriage movement unit 14. Further, the carriage 13 is connected to the control unit 15 by a flexible circuit 131, and performs printing processing by the printing section 16 and spectrometry processing by the spectroscope 17 based on an instruction from the control unit 15.

In addition, the detailed configuration of the carriage 13 will be described later.

The carriage movement unit 14 reciprocates the carriage 13 along the X direction based on the instruction from the control unit 15. The carriage movement unit 14 includes, for example, a carriage guide shaft 141, a carriage motor 142, and a timing belt 143.

The carriage guide shaft 141 is disposed along the X direction, and both end portions are fixed to, for example, a housing of the printer 10. The carriage motor 142 drives the timing belt 143. The timing belt 143 is supported substantially in parallel with the carriage guide shaft 141, and a part of the carriage 13 is fixed. In addition, when the carriage motor 142 is driven based on the instruction from the control unit 15, the timing belt 143 is driven in forward and reverse directions, and the carriage 13 fixed to the timing belt 143 is guided by the carriage guide shaft 141 to reciprocate.

Next, the configuration of the printing section 16 and the spectroscope 17 provided in the carriage 13 will be described based on the drawings.

### Configuration of Printing Section 16

The printing section 16 ejects the ink separately onto the medium M at a part opposing the medium M, and forms an image on the medium M.

For example, ink cartridges (not illustrated) that corresponds to the ink of a plurality of colors are attachably and detachably mounted to the printing section 16, and the ink is supplied via a tube (not illustrated) from each ink cartridge to an ink tank (not illustrated). In addition, nozzles (not illustrated) for ejecting ink droplets are provided corresponding to each of the colors on a lower surface (a position opposing the medium M) of the printing section 16. Piezo elements, for example, are disposed in nozzles, the piezo element is driven, and accordingly, ink droplets supplied from the ink tank are ejected and land on the medium M, and dots are formed.

### Configuration of Spectroscope 17

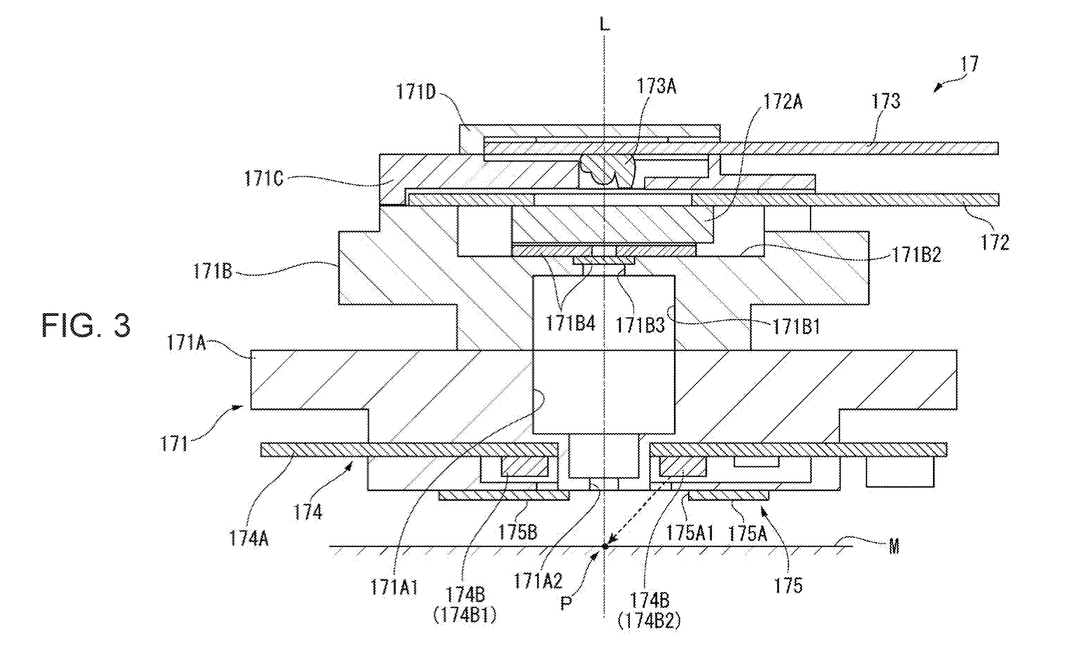

FIG. 3 is a sectional view illustrating a schematic configuration of the spectroscope 17.

As illustrated in FIG. 3, the spectroscope 17 is a spectrometric apparatus according to the invention, and includes a base 171, a filter holding substrate 172 held (fixed) to the base 171, a light receiving element holding substrate 173 fixed to the base 171, a light source section 174, a shutter 175, and a drive control section 176 (refer to FIG. 2).

### Configuration of Base 171

The base 171 is a member which is fixed to the carriage 13 and holds the filter holding substrate 172, the light receiving element holding substrate 173, the light source section 174, and the shutter 175. As illustrated in FIG. 3, the base 171 includes, for example, a first base portion 171A, a second base portion 171B, a third base portion 171C, and a fourth base portion 171D.

The first base portion 171A is fixed to the carriage 13 and has a first introduction hole 171A1 through which the light reflected by the medium M passes, at a position opposing a measurement position P of the medium M. The first introduction hole 171A1 is a hole portion having a tubular inner circumferential surface having an axis (an optical axis of a light receiving element 173A, and hereinafter referred to as a measurement optical axis L) parallel to a Z direction, and on the +Z side, an incident window 171A2 on which the light reflected by the medium M is incident is provided.

In addition, as illustrated in FIG. 3, the light source section 174 and the shutter 175 are provided on a surface (+Z side surface) opposing the medium M of the first base portion 171A.

The second base portion 171B is fixed to the side opposite to the medium M of the first base portion 171A. The second base portion 171B is provided with a second introduction hole 171B1 that communicates with the first introduction hole 171A1. The second introduction hole 171B1 is a hole portion having a tubular inner circumferential surface which is coaxial with the first introduction hole 171A1 (using the measurement optical axis L as the center axis).

A recess portion 171B2 is provided on the −Z side surface of the second base portion 171B. A through-hole 171B3 that communicates with the recess portion 171B2 and the second introduction hole 171B1 is provided on the bottom surface of the recess portion 171B2. The recess portion 171B2 is a space in which an optical member 171B4, such as a band pass filter or a lens, and a spectral filter 172A are disposed, and is a space sealed with the third base portion 171C.

In addition, a filter holding substrate 172 is fixed to the −Z side surface of the second base portion 171B so as to cover the recess portion 171B2. The fixing of the second base portion 171B and the filter holding substrate 172 can be exemplified by screwing, fixing with an adhesive or a resin member, for example. In the filter holding substrate 172, the spectral filter 172A is disposed, and the spectral filter 172A is disposed on the measurement optical axis L in the recess portion 171B2.

The third base portion 171C is fixed to the second base portion 171B, and the light receiving element holding substrate 173 is fixed. The fixing of the third base portion 171C and the light receiving element holding substrate 173 can be exemplified by screwing or fixing with an adhesive. As illustrated in FIG. 3, the third base portion 171C has a through-hole along the measurement optical axis L, and the light receiving element holding substrate 173 is fixed such that the light receiving element 173A provided on the light receiving element holding substrate 173 is disposed on the measurement optical axis L.

The fourth base portion 171D is a cover member and is provided to cover the −Z side surface of the light receiving element holding substrate 173 fixed to the third base portion 171C.

In addition, a light shielding member or the like is interposed between the third base portion 171C and the second base portion 171B, and between the third base portion 171C and the fourth base portion 171D, respectively, and accordingly, external light to the light receiving element 173A is prevented from being incident.

In addition, in the embodiment, an example is illustrated in which the incident window 171A2, the first introduction hole 171A1, the second introduction hole 171B1, the through-hole 171B3, the spectral filter 172A, and the light receiving element 173A are disposed coaxially, but the invention is not limited thereto. For example, the spectral filter 172A or the light receiving element 173A are provided on axes different from those of the first introduction hole 171A1 or the second introduction hole 171B1, and the light reflected by, for example, a mirror and incident from the incident window 171A2 may be received into the light receiving element 173A via the spectral filter 172A.

### Configuration of Filter Holding Substrate 172

As described above, the filter holding substrate 172 is fixed to the second base portion 171B of the base 171. The spectral filter 172A is fixed to the filter holding substrate 172. As the spectral filter 172A, for example, it is possible to use a variable wavelength interference filter having a pair of reflective films and changing a transmission wavelength by changing a distance between the reflective films. In addition, as the spectral filter 172A, in addition to this, grating elements, liquid crystal tunable filters, acousto-optic filters and the like may also be used.

Further, a driving circuit (driver circuit) or the like for driving the spectral filter 172A may be provided in the filter holding substrate 172.

### Configuration of Light Receiving Element Holding Substrate 173

As described above, the light receiving element holding substrate 173 is fixed to the third base portion 171C of the base 171. The light receiving element 173A is fixed to the light receiving element holding substrate 173. As the light receiving element 173A, for example, an image sensor, such as a charge coupled device (CCD), may be used, or may be configured with a single or a plurality of photodiodes.

In addition, the measurement section of the invention is configured with the spectral filter 172A held by the filter holding substrate 172 and the light receiving element 173A held by the light receiving element holding substrate 173.

The light receiving element holding substrate 173 may incorporate a light receiving circuit or the like for processing a light receiving signal from the light receiving element 173A.

### Configuration of Light Source Section 174

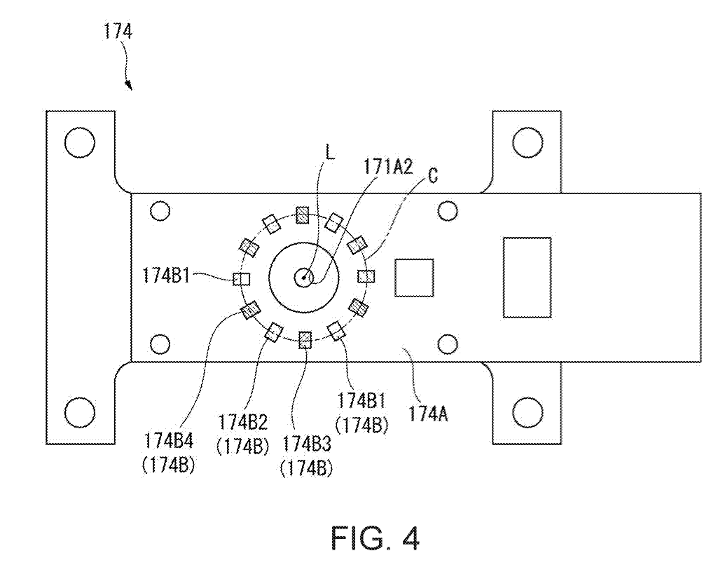

FIG. 4 is a plan view when the light source section 174 of the spectroscope 17 is viewed from the +Z side.

The light source section 174 includes a light source holding substrate 174A and a plurality of light sources 174B held by the light source holding substrate 174A. The plurality of light sources 174B have a plurality of light sources 174B along a virtual circle C around the measurement optical axis L. Specifically, as illustrated in FIG. 4, the plurality of light sources 174B are disposed at equal angular intervals (for example, at intervals of 30° in the embodiment) on the virtual circle C.

A diameter dimension of the virtual circle C is set, for example, in accordance with the distance from each of the light sources 174B to the platen 122. In other words, in the embodiment, the medium M on the platen 122 and the measurement position P in a predetermined range around an intersection point with the measurement optical axis L are irradiated with the light emitted from the light source 174B. Here, in the embodiment, the measurement by the spectroscope 17 is performed according to the method of (45°x:0°) under the optical geometric conditions prescribed by the colorimetric standard (JIS Z 8722). In other words, in the embodiment, the illumination light from the light source 174B is made incident on the measurement position P at an incident angle of 45°±2° and the light reflected in a normal direction at 0°±10° by the measurement target is incident on the light receiving element 173A along the measurement optical axis L. Therefore, it is preferable that each of the light sources 174B is respectively disposed at a position where the distance from the measurement optical axis L is a dimension that is substantially the same as the distance (a length of a perpendicular line when the perpendicular line is drawn from the light source 174B to the platen 122) from the light source 174B to the platen 122.

In addition, the plurality of light sources 174B include a plurality of types (four types) of light sources having different light wavelengths to be output, specifically, a white light source 174B1, a first excitation light source 174B2, a second excitation light source 174B3, and a third excitation light source 174B4.

The white light source 174B1 is configured with, for example, a white LED, and emits white light. In the embodiment, as illustrated in FIG. 4, the plurality (three in the embodiment) of white light sources 174B1 are disposed at intervals of 120°.

The first excitation light source 174B2 is a light source that outputs the first excitation light having a peak wavelength in a wavelength range of 420 nm or more and less than 490 nm. In the embodiment, a blue LED that outputs the first excitation light with the peak wavelength of 460 nm, for example, is used. In the embodiment, the plurality (three in the embodiment) of the first excitation light sources 174B2 are provided and disposed at intervals of 120°.

The second excitation light source 174B3 is a light source that outputs the second excitation light having a peak wavelength in a wavelength range of 490 nm or more and less than 600 nm. In the embodiment, an LED (green LED) that outputs the excitation light with the peak wavelength of 570 nm, for example, is used. In the embodiment, the plurality (three in the embodiment) of second excitation light sources 174B3 are provided and disposed at intervals of 120°.

The third excitation light source 174B4 is a light source that outputs the third excitation light (ultraviolet light) having a peak wavelength in a wavelength range of 380 nm or more and less than 420 nm. In the embodiment, an LED that outputs the ultraviolet excitation light with the peak wavelength of 380 nm, for example, is used. In the embodiment, the plurality (three in the embodiment) of the third excitation light sources 174B4 are provided and disposed at intervals of 120°.

The white light source 174B1, the first excitation light source 174B2, the second excitation light source 174B3, and the third excitation light source 174B4 can be independently driven.

In addition, each of the first excitation light source 174B2, the second excitation light source 174B3, and the third excitation light source 174B4 is a light source that outputs the excitation light of a single wavelength, and a half value width of each excitation light is, for example, 20 nm or less.

In addition, in the embodiment, the second excitation light source 174B3 and the third excitation light source 174B4 are disposed with the white light source 174B1 interposed therebetween along the circumferential direction of the virtual circle C, and the first excitation light source 174B2 is disposed at a position farthest from the white light source 174B1. In other words, in the embodiment, the white light source 174B1, the second excitation light source 174B3, the first excitation light source 174B2, and the third excitation light source 174B4 are arranged in this order along the circumferential direction of the virtual circle C.

Accordingly, it is possible to suppress the inconvenience that the first excitation light when the first excitation light source 174B2 emits light is incident on the white light source 174B1 and the white light source 174B1 emits light.

In addition, the light sources 174B may be provided to protrude from the −Z side surface of the light source holding substrate 174A, a recess portion that corresponds to each of the light sources 174B may be provided in the light source holding substrate 174A, and each one of light sources 174B may be provided in the recess portion. In a case where the light source 174B is provided in the recess portion, it is possible to more reliably suppress the inconvenience that the excitation light is incident on the white light source 174B1 when each of the light sources 174B is caused to emit light.

Here, each excitation light output from the first excitation light source 174B2, the second excitation light source 174B3, and the third excitation light source 174B4 will be described.

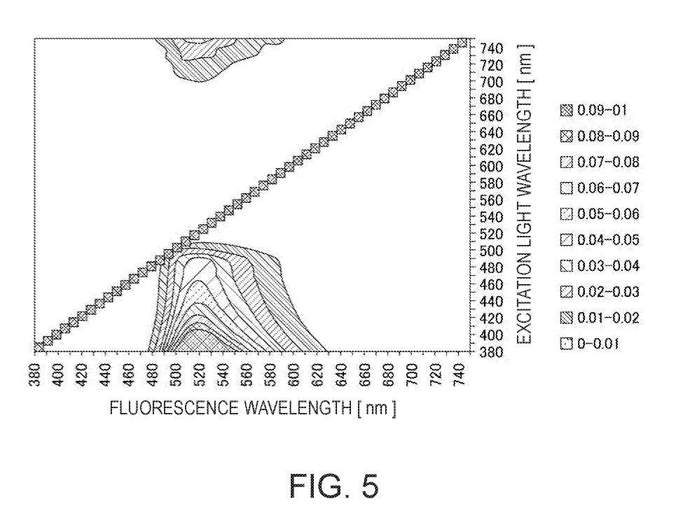

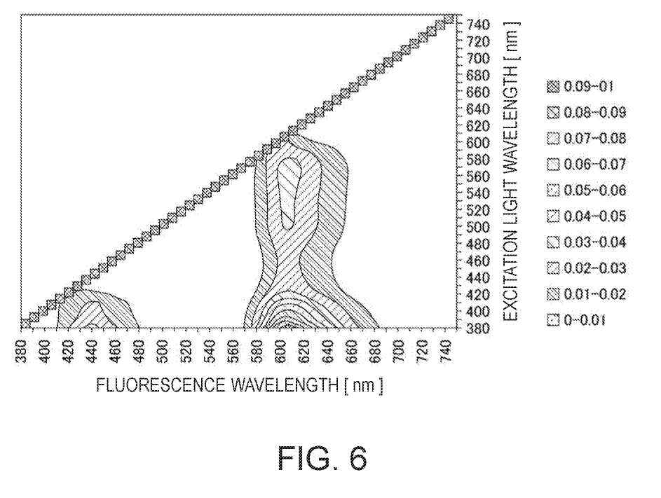

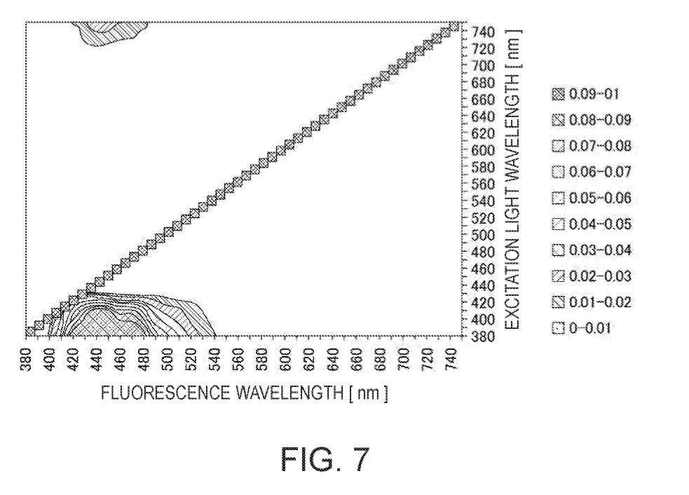

FIG. 5 is a view illustrating a relationship between a wavelength of the excitation light and a wavelength of fluorescence of fluorescent yellow excited by the excitation light. FIG. 6 is a view illustrating a relationship between the wavelength of the excitation light and a wavelength of fluorescence of fluorescent pink excited by the excitation light. FIG. 7 is a view illustrating a relationship between the wavelength of the excitation light and a wavelength of fluorescence of a fluorescent whitening agent excited by the excitation light.

As illustrated in FIG. 5, the fluorescence (hereinafter, there is a case of being referred to simply as fluorescent yellow) of the fluorescent yellow is generated by the yellow fluorescent material that emits yellow fluorescence as the light having a wavelength of the ultraviolet light (380 nm in FIG. 5) to 510 nm is excited as the excitation light. As illustrated in FIG. 5, the fluorescent yellow is light having an intensity distribution in a predetermined light emission wavelength range with a peak wavelength of 519 nm by the excitation light. Here, the light emission intensity and the light emission wavelength range of the fluorescent yellow change depending on the wavelength of the excitation light, and when the ultraviolet light is used as the excitation light, the strongest light intensity is emitted, the light emission wavelength range also becomes wide, and as the wavelength of the excitation light shifts to a long wavelength side, the light intensity gradually decreases and the light emission wavelength range also narrows.

Incidentally, when the fluorescent component is measured using the excitation light in the wavelength range of ultraviolet to less than 420 nm and colorimetry is performed under the optional illumination, the accuracy is low. This is because the fluorescent yellow is also excited by the excitation light of approximately 420 nm to 510 nm to generate fluorescence as described above, but the fluorescent component thereof is not included in colorimetry.

Meanwhile, in the embodiment, in addition to the excitation light source in the wavelength range of ultraviolet to less than 420 nm, the first excitation light source outputs the first excitation light having the peak wavelength in the wavelength range of 420 nm or more and less than 490 nm. Accordingly, the fluorescence properties of fluorescent yellow can be measured with high accuracy, and the colorimetry with high accuracy under the optional illumination can be performed.

In addition, as illustrated in FIG. 6, similar to the fluorescent yellow, by using the ultraviolet light as the excitation light, the fluorescent light having the strongest intensity can be obtained as fluorescent pink. However, unlike the fluorescent yellow illustrated in FIG. 5, the fluorescent component is measured using the excitation light in the wavelength range of less than 490 nm and the colorimetry is performed under the optional illumination, the accuracy is low. This is because the fluorescent pink is also excited by the excitation light of approximately 490 nm to 600 nm to generate fluorescence as described above, but the fluorescent component thereof is not included in colorimetry.

Meanwhile, in the embodiment, in addition to the excitation light source in the wavelength range of less than 490 nm, the second excitation light source outputs the second excitation light having the peak wavelength in the wavelength range of 490 nm or more and less than 600 nm. Accordingly, the fluorescence properties of fluorescent pink can be measured with high accuracy, and the colorimetry with high accuracy under the optional illumination can be performed.

In addition, in the embodiment, the third excitation light source 174B4 is the third excitation light having a peak wavelength between 380 nm or more and less than 420 nm. With the third excitation light source, it is possible to measure the fluorescence properties in the excitation light of 380 nm or more and less than 420 nm of the fluorescent whitening agent, the fluorescent yellow, and the fluorescent pink. Accordingly, by combining the fluorescence properties obtained by the first excitation light source and the second excitation light source to each other, it is possible to obtain the fluorescence properties of the fluorescent whitening agent, the fluorescent yellow, and the fluorescent pink which are required for the colorimetry under the optional illumination.

### Configuration of Shutter 175

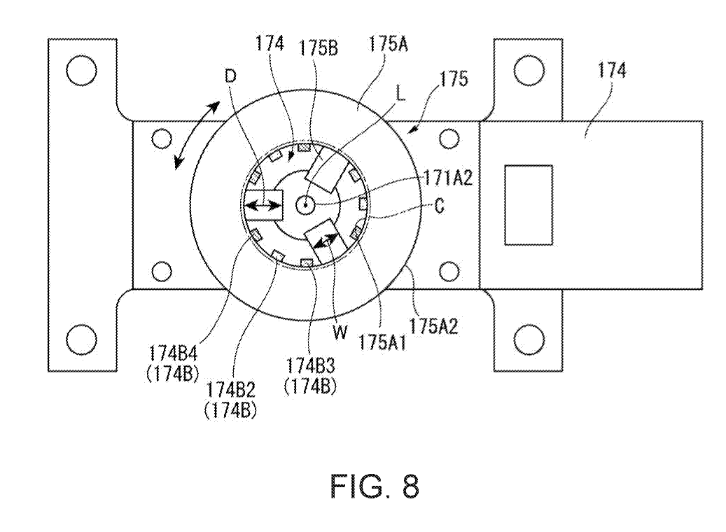

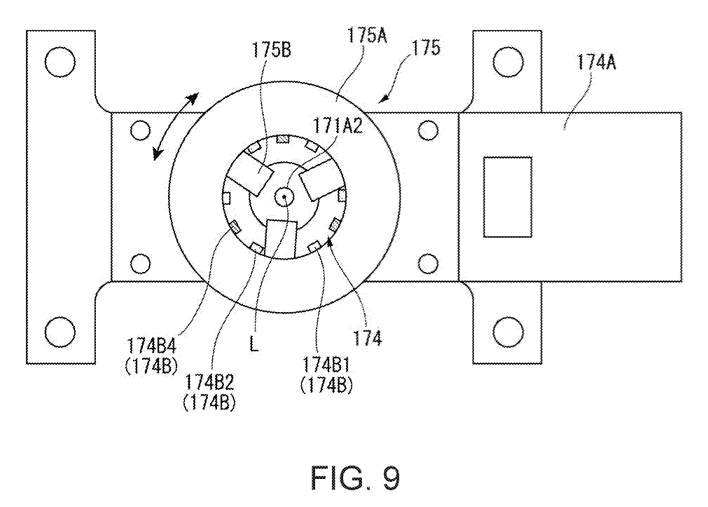

FIGS. 8 and 9 are plan views when the light source section 174 and the shutter 175 of the spectroscope 17 are viewed from the +Z side, FIG. 8 is a plan view when the shutter 175 is rotated to a light shielding position where the white light is shielded, and FIG. 9 is a plan view when the shutter 175 is rotated at an open position where the medium M is irradiated with the white light.

As illustrated in FIGS. 8 and 9, in a plan view when the spectroscope 17 is viewed from the −Z side, the shutter 175 includes an annular member 175A that surrounds each light source 174B of the light source section 174, and a light shielding section 175B that protrudes from an annular inner circumferential edge 175A1 of the annular member 175A to the measurement optical axis L side.

In addition, although not illustrated, the shutter 175 includes a rotary driving mechanism that rotates the annular member 175A around the measurement optical axis L along the circumferential direction of the virtual circle C. As the rotary driving mechanism, for example, a configuration including a gear (not illustrated) formed along an annular outer circumferential edge 175A2, a driving gear engaged with the gear, a stepping motor for step-driving the driving gear, and the like, can be exemplified.

The light shielding section 175B is a member that shields the white light from the white light source 174B1. A protrusion dimension D from the annular member 175A of the light shielding section 175B covers the white light source 174B1 and is a dimension that does not overlap the measurement optical axis L. In other words, the protrusion dimension D is a dimension by which the measurement position P of the medium M is not irradiated with the white light from the white light source 174B1 and the light reflected at the measurement position P is not interfered with the light shielding section 175B, when the shutter 175 is rotated and moved to the light shielding position.

A width dimension W (a dimension along a tangential direction of the virtual circle C) of the light shielding section 175B is a dimension with which the white light source 174B1 is covered and which does not overlap the second excitation light source 174B3 or the third excitation light source 174B4, when the shutter 175 is rotated and moved to the light shielding position.

In a case where each of the light sources 174B is stored in the recess portion provided in the base 171, the protrusion dimension D and the width dimension W that cover one recess portion may be set.

### Configuration of Drive Control Section 176

The drive control section 176 controls driving of the spectroscope 17 based on a control instruction of the control unit 15.

The drive control section 176 includes an arithmetic circuit, such as microcomputers, a storage circuit, such as memories, various driver circuits, and the like, and as illustrated in FIG. 2, functions as a filter control section 176A, a light receiving control section 176B, a light source control section 176C, and a shutter control section 176D.

The filter control section 176A controls the driving of the spectral filter 172A to change the wavelength of the light transmitted through the spectral filter 172A.

The light receiving control section 176B controls the driving of the light receiving element 173A and receives the light receiving signal output when the light receiving element 173A receives the light.

The light source control section 176C controls turning on and off of each of the light sources 174B of the light source section 174. For example, in the embodiment, in a case of measuring the chromaticity at the measurement position P of the medium M, the white light source 174B1, the first excitation light source 174B2, the second excitation light source 174B3, and the third excitation light source 174B4 are turned on and off in order.

The shutter control section 176D corresponds to the light shielding control section of the invention and controls the position of the shutter 175. Specifically, in a case of measuring the chromaticity at the measurement position P of the medium M, the shutter control section 176D rotates and moves the annular member 175A when turning on the white light source 174B1 and moves the shutter 175 to the open position. Meanwhile, when the first excitation light source 174B2, the second excitation light source 174B3, and the third excitation light source 174B4 are turned on, the shutter control section 176D rotates and moves the annular member 175A and moves the shutter 175 to the light shielding position.

### Configuration of Control Unit

As illustrated in FIG. 2, the control unit 15 is a control section according to the invention, and includes an I/F 151, a unit control circuit 152, a memory 153, and a central processing unit (CPU) 154.

The I/F 151 inputs the printing data input from the external device 20 to the CPU 154.

The unit control circuit 152 includes control circuits for controlling each of the supply unit 11, the transport unit 12, the printing section 16, the spectroscope 17, and the carriage movement unit 14, respectively, and controls the operation of each unit based on an instruction signal from the CPU 154. In addition, the control circuit of each unit may be provided separately from the control unit 15 and may be connected to the control unit 15.

The memory 153 stores various programs or various data for controlling the operation of the printer 10.

Examples of the various data include a drive table indicating a control value of the spectral filter 172A with respect to the wavelength of the light transmitted through the spectral filter 172A, print profile data that stores the ejection amount of each ink with respect to the color data included as the printing data.

The CPU 154 reads and executes the various programs stored in the memory 153, and accordingly, executes the colorimetric processing or the correction (update) processing of print profile data based on the result of a driving control of each of the units 11, 12, and 14, the print control of the printing section 16, the measurement control by the spectroscope 17, and the spectrometry of the spectroscope 17.

### Spectrometric Method

Next, the spectrometric method (spectrometry processing) with respect to the medium M in the printer 10 as described above will be described hereinafter.

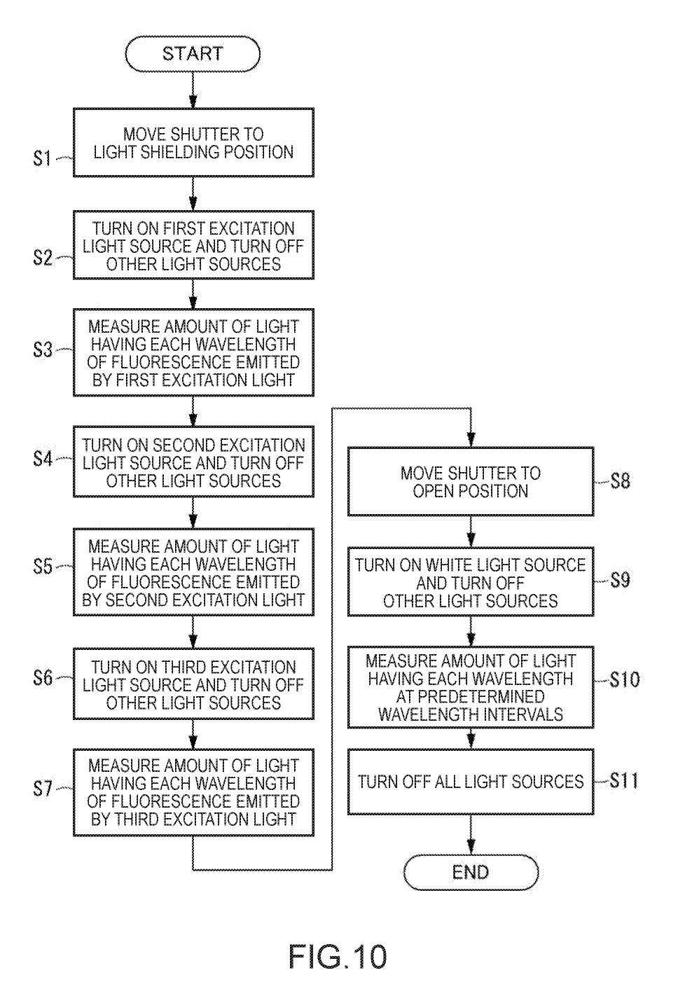

FIG. 10 is a flowchart illustrating the spectrometry processing in the embodiment.

In fluorescence measurement processing according to the embodiment, for example, when the printer 10 receives an instruction to execute the spectrometry on the medium M, for example, by a user operation or an input from the external device 20, the control unit 15 outputs a measurement instruction for instructing the spectrometry processing with respect to the spectroscope 17.

When receiving the measurement instruction, the spectroscope 17 first performs the fluorescence measurement processing. Accordingly, first, the shutter control section 176D controls the rotary driving mechanism of the shutter 175 and moves the shutter 175 to the light shielding position (step S1). Accordingly, the light shielding section 175B is moved to a position where the white light from the white light source 174B1 is shielded.

Next, the light source control section 176C turns on the first excitation light source 174B2 and turns off the white light source 174B1, the second excitation light source 174B3, and the third excitation light source 174B4 (step S2).

Accordingly, the measurement position P of the medium M is irradiated with the first excitation light from the first excitation light source 174B2. In a case where there is ink containing a yellow fluorescent material or a pink color fluorescent material which generates fluorescent yellow or fluorescent pink at the measurement position P, for example, the fluorescent material is excited by the first excitation light to emit fluorescent light of fluorescent yellow or fluorescent pink.

In addition, the filter control section 176A controls the spectral filter 172A to sequentially change the wavelength of light transmitted through the spectral filter 172A, and the light receiving control section 176B receives the light receiving signal that corresponds to the amount of received light of each wavelength from the light receiving element 173A (step S3). In other words, the amount of light of each wavelength at predetermined wavelength intervals of fluorescence (fluorescent yellow or fluorescent pink) which is emitted by the first excitation light is measured.

Next, the light source control section 176C turns on the second excitation light source 174B3 and turns off the white light source 174B1, the first excitation light source 174B2, and the third excitation light source 174B4 (step S4). In addition, the filter control section 176A controls the spectral filter 172A to sequentially change the wavelength of light transmitted through the spectral filter 172A, and the light receiving control section 176B receives the fluorescent component of fluorescent pink from the light receiving element 173A by the light receiving signal that corresponds to the amount of received light of each wavelength (step S5). In other words, the amount of light of each wavelength at predetermined wavelength intervals of fluorescence (fluorescent pink) which is emitted by the second excitation light is measured.

Furthermore, the light source control section 176C turns on the third excitation light source 174B4 and turns off the white light source 174B1, the first excitation light source 174B2, and the second excitation light source 174B3 (step S6). In addition, the filter control section 176A controls the spectral filter 172A and receives the fluorescent component of the fluorescent yellow, the fluorescent pink, and the fluorescent whitening agent from the light receiving element 173A by the light receiving signal that corresponds to the amount of received light of each wavelength (step S7). In other words, the amount of light of each wavelength at predetermined wavelength intervals of fluorescence (the fluorescent yellow, the fluorescent pink, and the fluorescent color emitted by the fluorescent whitening agent) which is emitted by the third excitation light is measured.

In addition, the fluorescence measurement results (amounts of light that correspond to the light receiving signals) obtained in steps S3, S5, and S7 are respectively transmitted to the control unit 15 and stored in the memory 153.

In addition, here, an example in which the processing from step S3 to step S7 is respectively performed once is illustrated, but the processing from step S3 to step S7 may be performed a plurality of times and the average value of the measured amount of the light may be obtained.

Next, the spectroscope 17 performs color measurement processing. Accordingly, the shutter control section 176D controls the rotary driving mechanism of the shutter 175 and moves the shutter 175 to the open position (step S8). Accordingly, the light shielding section 175B retracts from the white light source 174B1 and moves to a position where the measurement position P can be irradiated with the white light.

After this, the light source control section 176C turns on the white light source 174B1 and turns off the first excitation light source 174B2, the second excitation light source 174B3, and the third excitation light source 174B4 (step S9).

In addition, the filter control section 176A controls the spectral filter 172A to sequentially change the wavelength of light transmitted through the spectral filter 172A, and the light receiving control section 176B receives the light receiving signal that corresponds to the amount of received light of each wavelength from the light receiving element 173A (step S10). In other words, the amounts of light at predetermined wavelength intervals included in the light reflected at the measurement position P are measured, respectively. The color measurement results (amounts of light that corresponds to the light receiving signals) obtained in step S10 are transmitted to the control unit 15 and stored in the memory 153.

After this, the light source control section 176C turns off all of the light sources 174B (step S11).

After the above-described spectrometry processing by the spectroscope 17, the control unit 15 performs colorimetric processing based on the color measurement result obtained in step S10 and the fluorescence measurement result obtained in step S3 to step S7. Examples of the colorimetric processing include calculation of reflectance for each wavelength, calculation of color coordinate values, such as RGB, and the like are performed based on the color measurement result and the fluorescence measurement result. At this time, it is possible to perform the colorimetry with high accuracy under the optional illumination including fluorescence based on the colorimetric result.

### Operational Effect of Embodiment

In the embodiment, the spectroscope 17 includes the plurality of light sources 174B including the first excitation light source 174B2, the second excitation light source 174B3, and the third excitation light source 174B4, and a light source control section 176C that controls the light sources 174B. In addition, the light source control section 176C sequentially switches the first excitation light source 174B2, the second excitation light source 174B3, and the third excitation light source 174B4 when performing the fluorescence measurement processing.

Accordingly, in the spectroscope 17, each excitation light of the first excitation light source 174B2, the second excitation light source 174B3, and the third excitation light source 174B4 are alternately switched, and the fluorescence that corresponds to each excitation light is alternately emitted. Therefore, in the spectroscope 17, the fluorescence properties for each fluorescence can be respectively individually measured with high accuracy.

The first excitation light source 174B2 outputs the first excitation light of 420 nm or more and less than 490 nm. By the first excitation light, fluorescence of fluorescent yellow around the wavelength of 519 nm is generated. In addition to the excitation light source in the wavelength range from ultraviolet to less than 420 nm, by outputting the first excitation light, the fluorescence properties of the fluorescent yellow can be measured with high accuracy and the colorimetry with high accuracy under the optional illumination can be obtained.

The second excitation light source 174B3 outputs the second excitation light of 490 nm or more and less than 600 nm.

By the second excitation light, fluorescence of fluorescent pink around the wavelength of 606 nm is generated. In addition to the excitation light source in the wavelength range from ultraviolet to less than 490 nm, by outputting the second excitation light, the fluorescence properties of the fluorescent pink can be measured with high accuracy, and the colorimetry with high accuracy under the optional illumination can be obtained.

The third excitation light source 174B4 outputs the third excitation light of 380 nm or more and less than 420 nm. With such a third excitation light source, it is possible to measure the fluorescence properties in the excitation light of 380 nm or more and less than 420 nm of the fluorescent whitening agent, the fluorescent yellow, and the fluorescent pink. Accordingly, by combining the fluorescence properties obtained by the first excitation light source and the second excitation light source to each other, it is possible to obtain the fluorescence properties of the fluorescent whitening agent, the fluorescent yellow, and the fluorescent pink which are required for the colorimetry under the optional illumination.

The spectroscope 17 of the embodiment further includes the white light source 174B1 that outputs white light. In addition, while the light source control section 176C turns on any of the first excitation light source 174B2, the second excitation light source 174B3, and the third excitation light source 174B4, the light source control section 176C turns off the white light source 174B1, and while the light source control section 176C turns on the white light source 174B1, the light source control section 176C turns off the first excitation light source 174B2, the second excitation light source 174B3, and the third excitation light source 174B4.

Accordingly, the color measurement of the medium M using the white light can be performed. In addition, by combining the measurement result using the white light source 174B1 and the fluorescence properties obtained by the first excitation light source 174B2, the second excitation light source 174B3, and the third excitation light source 174B4, the colorimetry with high accuracy under the optional illumination becomes possible.

In the embodiment, the shutter 175 including the light shielding section 175B provided so as to be capable of advancing and retreating on the optical path of the white light output from the white light source 174B1 is provided. In addition, when the shutter control section 176D turns on any of the first excitation light source 174B2, the second excitation light source 174B3, and the third excitation light source 174B4, the shutter control section 176D moves the shutter 175 to the light shielding position where the light shielding section 175B is positioned on the optical path of the white light.

Accordingly, it is possible to suppress the inconvenience that the excitation light is incident on the fluorescent material included in the white light source 174B1, fluorescence is emitted, and the medium M is irradiated with the white light.

In the embodiment, the white light source 174B1, the first excitation light source 174B2, the second excitation light source 174B3, and the third excitation light source 174B4 are respectively provided three by three, and are disposed along the circumferential direction of the virtual circle C at intervals of 30°.

Accordingly, the distance or the angle from each of the excitation light sources 174B2, 174B3, and 174B4 to the measurement position P can be made uniform, and the measurement of the fluorescence properties for each of the fluorescent colors can be performed with high accuracy. In addition, even in a case where there is unevenness on the surface of the medium M, inconveniences and the like in which a shadow is formed are suppressed, and the measurement with high accuracy can be performed.

In addition, the first excitation light source 174B2, the second excitation light source 174B3, and the third excitation light source 174B4 are disposed between the two adjacent white light sources 174B1 along the circumferential direction such that the second excitation light source 174B3, the first excitation light source 174B2, and the third excitation light source 174B4 are disposed in this order.

In the embodiment, a white LED is used as the white light source 174B1. Although there are various methods of light emission of such a white LED, as a configuration for obtaining the white color with high luminous efficiency, there is a configuration in which a blue LED is turned on and a yellow fluorescent substance is made to emit light to obtain the white color.

Meanwhile, the first excitation light source 174B2 is a light source that outputs the blue light as the first excitation light, and when the blue light is incident on the white LED, the yellow fluorescent substance emits light, and the medium M is irradiated with the light from the white light source 174B1. In this case, inconvenience such as deterioration of the measurement accuracy of the fluorescence properties occurs.

On the other hand, in the application example, the first excitation light source 174B2 is disposed at a position farthest from the white light source 174B1. Accordingly, it is possible to suppress the inconvenience that the first excitation light is incident on the white light source 174B1, and the medium M is irradiated with the white light.

In the embodiment, the shutter 175 includes the annular member 175A and the light shielding section 175B, and the light shielding section 175B is provided to protrude toward the measurement optical axis L on the inside of the annular member 175A.

With such a configuration, by rotating the annular member 175A, it is possible to easily move between the light shielding position for shielding the white light from the white light source 174B1 and the open position for retracting from the white light source 174B1.

### Modification Example

In addition, the invention is not limited to the above-described embodiments, and variations, improvements, and the like within the scope that can achieve an object of the invention are included in the invention.

For example, in the above-described embodiment, an example is described in which the fluorescence properties of fluorescent colors of which each is a target of the measurement, such as fluorescent color (peak wavelength of 443 nm) by the fluorescent whitening agent, fluorescent yellow (peak wavelength of 519 nm), and fluorescent pink (peak wavelength of 606 nm) are measured, but the fluorescence properties of other fluorescent colors may be measured. In this case, the wavelength of the excitation light including the excitation wavelength range of the fluorescent color may be set.

In other words, in the spectrometric apparatus according to the invention, the fluorescence properties of each of the first fluorescence which is excited by the first excitation light of the first wavelength range and uses the first fluorescence wavelength as the peak wavelength and the second fluorescence which is excited by the second excitation light of the second wavelength range and uses the second fluorescence wavelength as the peak wavelength, are measured.

By alternately switching on the first excitation light source and the second excitation light source by using the first excitation light source and the second excitation light source that output the first excitation light and the second excitation light as described above, it is possible to measure respective fluorescence properties with high accuracy.

In addition, in the above-described embodiment, the second excitation light source 174B3 that outputs the second excitation light having the peak wavelength between 490 nm or more and less than 600 nm is used when measuring the fluorescence properties of the fluorescent pink, but the second excitation light source 174B3 may not be provided, and the measurement using only the first excitation light source 174B2 may be performed.

In other words, as illustrated in FIGS. 5 and 6, the first excitation light (light having a peak wavelength in the wavelength range of 420 nm or more and less than 490 nm) excites both the fluorescent yellow and the fluorescent pink, but the light of which the peak wavelength of the fluorescent yellow is 519 nm may not be included in the fluorescent pink, and the light of which the peak wavelength of the fluorescent pink is 606 nm may not be included in the fluorescent yellow. Therefore, by switching the wavelength of the light transmitted through the spectral filter 172A between 519 nm and 606 nm while keeping the first excitation light source 174B2 turned on, it is possible to measure respective fluorescence properties of the fluorescent yellow and the fluorescent pink.

In the above-described embodiment, an example in which the fluorescence measurement is performed in the order of measurement by the first excitation light in step S2 and step S3, measurement by the second excitation light in step S4 and step S5, and measurement by the third excitation light in step S6 and step S7, is described, but the order of the measurements is not particularly limited. For example, after the measurement with the third excitation light is performed, the measurement with the second excitation light may be performed, and after this, the measurement with the first excitation light may be performed.

In the above-described embodiment, an example in which, in the measurement of the fluorescence properties of each fluorescent color, the filter control section 176A changes (for example, lowers) the light transmitted through the spectral filter 172A at predetermined wavelength intervals, receives each of the respective light receiving signals of each of the wavelengths, and acquires fluorescence spectrum data is described.

On the other hand, for example, the wavelength of the light transmitted through the spectral filter 172A is set to a wavelength that corresponds to the peak wavelength of each fluorescence, and the fluorescence properties for each color fluorescence may be measured based on the light intensity of the peak wavelength of fluorescence of each color.

For example, in a case of measuring the fluorescence properties of fluorescent yellow or measuring the presence or absence of fluorescent yellow, the first excitation light source 174B2 is turned on and the white light source 174B1, the second excitation light source 174B3, and the third excitation light source 174B4 are turned off. In addition, the wavelength of the light transmitted through the spectral filter 172A is set to a wavelength of 519 nm which is the peak wavelength of fluorescent yellow. Here, in order to measure the fluorescence properties of only fluorescent yellow, when the third excitation light having a wavelength of 380 nm or more and less than 420 nm is used, the fluorescent whitening agent is also excited to emit fluorescence, and as illustrated in FIG. 7, the fluorescence includes the light from 400 nm to 540 nm. Accordingly, in a case where it is desired to measure the fluorescence properties of only fluorescent yellow, the measurement accuracy deteriorates. On the other hand, in the first excitation light, excitation of the fluorescent whitening agent is suppressed, and thus, the fluorescence properties of fluorescent yellow can be appropriately measured.

In addition, in a case of measuring the fluorescence properties of fluorescent pink or measuring the presence or absence of fluorescent pink, the second excitation light source 174B3 is turned on and the white light source 174B1, the first excitation light source 174B2, and the third excitation light source 174B4 are turn off. In addition, the wavelength of the light transmitted through the spectral filter 172A is set to a wavelength of 606 nm which is the peak wavelength of fluorescent pink.

Here, in order to measure the fluorescence properties of only fluorescent pink, when the third excitation light having a wavelength of 380 nm or more and less than 420 nm is used, the yellow fluorescent material is also excited to emit fluorescent yellow, and as illustrated in FIG. 5, the fluorescence includes the light from 480 nm to 620 nm. Accordingly, in a case where it is desired to measure the fluorescence properties of only fluorescent pink, the measurement accuracy deteriorates. In addition, in a case of using the first excitation light, the light included in the fluorescent yellow becomes light in the wavelength range of 480 nm to 600 nm and does not include light of 606 nm (which transmits the spectral filter 172A) of measurement target. However, as illustrated in FIG. 6, a sufficient amount of light cannot be obtained with the fluorescent pink excited by the first excitation light, and the measurement accuracy deteriorates. On the other hand, in a case of using the second excitation light, the excitation of the yellow fluorescent material or the fluorescent whitening agent is suppressed, the fluorescent pink also emits light with sufficient light emission intensity, and thus, it is possible to appropriately measure the fluorescence properties of the fluorescent pink.

As the shutter 175, a configuration in which the light shielding section 175B protrudes from the annular inner circumferential edge 175A1 of the annular member 175A, the annular member 175A is rotationally driven, and accordingly, the light shielding section 175B advances and retreats on the optical path of the white light of the white light source has been exemplified, but the invention is not limited thereto. As the shutter, for example, the light shielding section may be configured to advance and retreat along a linear direction. For example, a configuration in which the light shielding section which is capable of advancing and retreating in a radial direction of the virtual circle C is provided for each of the white light sources 174B1 disposed at intervals of 120°, may be employed.

In the above-described embodiment, a configuration in which the light shielding section 175B advances and retreats with respect to the optical axis of the white light source 174B1 to suppress the inconvenience of irradiating the medium M with the white light during the fluorescence measurement processing has been exemplified. On the other hand, the light shielding section may be provided for each of the light sources 174B. For example, a configuration in which the light shielding sections 175B are formed in an arc shape along the circumferential direction of the virtual circle C, the three light sources 174B are capable of shielding the light, and the light shielding sections 175B are disposed at intervals of 120° may be employed. In this case, the medium M which is the measurement target is irradiated with the light of the light source 174B disposed between the adjacent light shielding sections 175B in the circumferential direction, and the light from the other light sources 174B is shielded by the light shielding section 175B.

In the above-described embodiment, a configuration in which the white light sources 174B1, the first excitation light sources 174B2, the second excitation light sources 174B3, and the third excitation light sources 174B4 are respectively provided three by three, and various light sources are respectively disposed at intervals of 120° has been exemplified, but the invention is not limited thereto.

For example, a configuration in which three light sources 174B of the same type are disposed adjacent to each other in the circumferential direction at intervals of 30°, or the like, may be employed. Even in this case, even in a case where the medium M has irregularities as the medium M is irradiated with light from a plurality of directions, the influence of shadows can be suppressed.

In addition, a configuration in which each of the light sources 174B are arranged along the circumferential direction of the virtual circle C has been exemplified, but the invention is not limited thereto. For example, the white light source 174B1 may be disposed along the circumferential direction of the first virtual circle around the measurement optical axis L, and each of the excitation light sources 174B2, 174B3, and 174B4 may be disposed in the circumferential direction of a second virtual circle having a diameter dimension different from that of a first virtual circle.

In addition, a configuration in which the white light source 174B1, the first excitation light source 174B2, the second excitation light source 174B3, and the third excitation light source 174B4 are respectively disposed one by one along the first virtual circle, and the white light source 174B1, the first excitation light source 174B2, the second excitation light source 174B3, and the third excitation light source 174B4 are respectively disposed two by two along the second virtual circle having a diameter greater than that of the first virtual circle, or the like, may be employed.

In the above-described embodiment, by providing the white light source 174B1, the color measurement of the medium M which is the measurement target can be performed, but, for example, in a case of measuring only the fluorescence properties of the fluorescent color, or the like, the white light source 174B1 may be disposed. In addition, in this case, the shutter 175 (light shielding section 175B) can be made unnecessary.

In addition to this, the specific structure when realizing the invention can be appropriately changed to other structures or the like within the range where an object of the invention can be achieved.

The entire disclosure of Japanese Patent Application No. 2017-207920 filed on Oct. 27, 2017 is expressly incorporated by reference herein.

What is claimed is:

1. A spectrometric apparatus comprising:
an excitation light source that outputs excitation light to a measurement target;
a light source controller that controls driving of the excitation light source; and
a measurement section that performs spectrometry of light reflected by the measurement target,
wherein a plurality of types of the excitation light sources are provided corresponding to a plurality of types of fluorescence having different peak wavelengths, and
wherein the light source controller sequentially changes the excitation light sources to be turned on in a manner to turn on one type of the excitation light sources among the plurality of types of the excitation light sources and turn off other types of excitation light sources.

2. The spectrometric apparatus according to claim 1,
wherein the excitation light source includes a first excitation light source that outputs first excitation light having a peak wavelength in a wavelength range of 420 nm or more and less than 490 nm.

3. The spectrometric apparatus according to claim 1,
wherein the excitation light source includes a second excitation light source that outputs second excitation light having a peak wavelength in a wavelength range of 490 nm or more and less than 600 nm.

4. The spectrometric apparatus according to claim 1,
wherein the excitation light source includes a third excitation light source that outputs third excitation light having a peak wavelength in a wavelength range of 380 nm or more and less than 420 nm.

5. The spectrometric apparatus according to claim 1, further comprising:
a white light source for outputting white light to the measurement target,
wherein the light source controller controls driving of the excitation light source and the white light source, turns off the white light source while the excitation light source is turned on, and turns off the excitation light source while the white light source is turned on.

6. The spectrometric apparatus according to claim 5, further comprising:
a light shielding section that is provided so as to be capable of advancing and retreating on an optical path of the white light output from the white light source; and
a light shielding controller that controls movement of the light shielding section,
wherein the light shielding controller moves the light shielding section on the optical path of the white light when turning on the excitation light source.

7. The spectrometric apparatus according to claim 1,
wherein the plurality of types of excitation light sources are respectively provided and are disposed along a circumferential direction of a virtual circle around the measurement section when viewed from a direction oriented toward the measurement section from the measurement target.

8. A spectrometric method which uses a spectrometric apparatus including a plurality of types of excitation light sources that output excitation light to a measurement target, and have different wavelengths of the excitation light, and a measurement section that performs spectrometry of light reflected by the measurement target, the method comprising:
measuring the light reflected by the measurement target by the measurement section while sequentially changing the excitation light source to be turned on in a manner to turn on one type of the excitation light sources among the plurality of types of the excitation light sources and turn off other types of excitation light sources.
